(19) United States
(12) Patent Application Publication
(10) Pub. No.: US 2009/0301145 A1
(43) Pub. Date: Dec. 10, 2009

(54) PADLOCK

(75) Inventors: Theodore Valerio, Perth (AU); Stephen Payne, Perth (AU)

Correspondence Address: MAIER & MAIER, PLLC, 1000 DUKE STREET, ALEXANDRIA, VA, 22314, US

(73) Assignee: Origineering Pty. Ltd., Perth (AU)

(21) Appl. No.: 12/515,296

(22) PCT Filed: Oct. 17, 2007
(86) PCT No.: PCT/AU2007/001584

§ 371 Date: May 18, 2009

(30) Foreign Application Priority Data
Nov. 24, 2006 (AU) 2006906576
May 21, 2007 (AU) 2007902714

(51) Int. Cl. E05B 67/12; E05B 37/00; E05B 27/00

(52) U.S. Cl. 70/21; 70/53; 70/490

(57) ABSTRACT

A padlock comprising a lock body, a plurality of shackles extending from the lock body and a locking mechanism. Each shackle is moveable between a closed position and an open position. The locking mechanism is engageable with each of the shackles such that operation of the locking mechanism with an access control means is required to move any shackle in the closed position to the open position. Severing one of the shackles in the closed position results in one of the other shackles being in the open position and free to move to the closed position.

### FIELD OF THE INVENTION

The present invention relates to a padlock and relates particularly, though not exclusively to a padlock suitable for improving the security of airline luggage inspection.

### BACKGROUND TO THE INVENTION

Due to the need to improve airport security the Transportation Security Administration (TSA) in the USA has requested that airline passengers not use padlocks on the zippers of their luggage. The TSA conducts random internal inspections on airport luggage. Approximately one in every six items of luggage are inspected. If a conventional padlock has been used to secure the zipper or other closure, it would typically be “clipped” by the TSA should that item of luggage be subject to an internal inspection. The padlock of a selected item of luggage is usually removed by cutting through the shackle of the lock with a pair of bolt cutters or similar tool. Consequently, a variety of specialised locks have been designed that can be re-attached to the luggage closure after they have been removed by a Luggage Inspector.

U.S. Pat. No. 7,021,537 B2 (Tropp) and U.S. Pat. No. 7,037,728 B2 (Tropp) both relate to this type of system, in which a special lock is made available to airline travellers, the special lock typically having a combination lock portion and a master key lock portion. A master key, that can open the master key lock portion, is made available to airport security personnel to enable them to open the special lock in order to conduct an internal inspection of an item of luggage, and then securely reapply the lock to the item of luggage after the inspection. The special lock has an indicia provided on it indicating to airport security personnel that the lock can be opened using the master key. The TSA in the USA and other luggage screening authorities, now recognise such systems and the associated specialised padlocks. Most of the current specialised padlocks involve the use of a range of pass-keys that are held by the relevant agencies for this purpose. One of the problems with such prior art systems is that there is no way of identifying whether access to the item of luggage was conducted by authorised security personnel. If a copy of the pass-key has fallen into the hands of an unauthorised person, they can open the special lock and remove valuables from, or plant an object in, the item of luggage undetected. Also, in order to work this system it is required that all security personnel be issued with the pass-keys for every variety of lock that is currently on the market. This will become unmanageable as the number and variety of locks increases.

The present invention was developed with a view to providing a padlock that does not require the use of a special pass-key to be opened and can be reapplied to an item of luggage. It will be appreciated that the padlock of the present invention will also have many other applications and is not limited in its use to securing items of luggage.

References to prior art documents in this specification are provided for illustrative purposes only and are not to be taken as an admission that such prior art is part of the common general knowledge in Australia or elsewhere.

### SUMMARY OF THE INVENTION

According to a first aspect of the present invention, there is provided a padlock comprising:

a lock body;

a plurality of shackles extending from the lock body, each shackle being moveable between a closed position and an open position; and

a locking mechanism engageable with each of the shackles such that operation of the locking mechanism with an access control means is required to move any shackle in the closed position to the open position;

wherein severing one of the shackles in the closed position results in one of the other shackles being in the open position and free to move to the closed position.

In one embodiment, when one of the shackles is in the closed position, the other shackles are prevented from being in the closed position and severing the closed shackle allows closing of one of the open shackles.

In a preferred embodiment, each of the shackles comprise part of an integral shackle member. The integral shackle member may comprises a double sided shackle, the first end of the double sided shackle comprising a first shackle and the second end of the double sided shackle comprising a second shackle such that moving the first shackle to the closed position results in the second shackle being moved to the open position and moving the first shackle to the open position results in the second shackle being moved to the closed position.

Preferably, each of the shackles move slidably between the closed and open positions and each of the shackles interengage such that rotation of a portion of the severed shackle causes the other shackle to move to the open position by said interengagement.

In a preferred embodiment, the double sided shackle includes an intermediate portion between the first and second ends and the locking mechanism includes a tongue member that engages with a first recessed portion in the intermediate portion when the first shackle is in the closed position and with a second recessed portion in the intermediate portion when the second shackle is in the closed position such that engagement of the tongue member with either the first or second recessed portions prevents sliding movement of the double sided shackle and wherein rotational motion of the double sided shackle is prevented by one of the shackles being in the closed position.

The intermediate portion may include a cam portion between the first and second recessed portions and wherein the first and second recessed portions are arranged such that rotational motion of the double sided shackle after severing the closed shackle moves the tongue member out of the recessed portion and allows the double sided shackle to slide to a position in which the tongue member is in the cam portion, the double sided shackle then being in a neutral position with neither the first or second shackles being closed.

Advantageously, the severed shackle is removable from the lock body for replacement.

The intermediate portion may be received in a transverse groove in the lock body and wherein the double sided shackle can be removed from the transverse groove to allow replacement of the double sided shackle.

The locking control mechanism may comprise a lock barrel and the access control means comprises a key. In an alternative embodiment, the locking mechanism comprises a combination type lock.

In a further embodiment, each of the shackles can simultaneously be in the closed position and severing of any shackle in the closed position causes other shackles in the closed position to move to the open position.

Preferably, the padlock includes a first shackle and a second shackle extending from opposed sides of the lock body. The locking mechanism preferably includes a key barrel arranged in the lock body such that rotation of the key barrel with a key causes the first and second shackles to move to the open position. Alternatively, the locking mechanism may comprise a combination type lock and operation of the combination type lock causes the first and second shackles to move to the open position.

In one embodiment, each of the first and second shackles includes a first end and a second end, the first end being retained in the lock body by a retaining spring in the open position and the second end being engaged by a first latch plate in the closed position to hold the second end in the lock body in the closed position.

A second latch plate is preferably provided in engagement with the first latch plate and the key barrel such that rotation of the key barrel causes translation of the second latch plate and thereby of the first latch plate. The first latch plate may include a first hole into which is received the second end of the shackle, the second end having a first notch engaged by the edge of the hole to retain the second end of the shackle in the closed position.

The retaining spring preferably includes a pair of arms that engage with a circular groove in the first end of the shackle to retain the shackle and the second latch plate engages with the arms of the retaining spring in the closed position such that severing the shackle in the closed position allows release of the first end of the shackle from the lock body.

Ejector springs may be provided between the first end of the first shackle and the second end of the second shackle and between the second end of the first shackle and the first end of the second shackle such that the ejector springs eject the first end of the severed shackle from the lock body.

In a preferred embodiment, the first ends of the first and second shackles include a second notch which receives an end of the corresponding first latch plate and wherein during the ejection of the first end of the shackle, the first latch plate rides out of the second notch disengaging the first latch plate from the second end of the severed shackle, thereby allowing ejection of the second end of the severed shackle by the ejector spring. Preferably, the first and second notches are shaped such that rotation of either the first end or the second end of the severed shackle causes movement of the first latch plate to disengage the first latch plate from both the first and second notches, thereby allowing ejection of the first and second ends of the severed shackle.

Advantageously, a latch interconnect member is provided, the latch interconnect member being engaged by the second latch plate of the severed shackle such that the latch interconnect causes movement of the second latch plate and the first latch plate of the unsevered shackle to allow the unsevered shackle to move to the open position. The latch interconnect may comprise an elliptical member having opposed arms that engage with the second latch plates of the first and second shackles, the elliptical member having an elliptical opening receiving a post member provided on the inside of the lock body.

The lower surface of the elliptical member may include lugs which slide in slots provided in the inner surface of the lock body such that the elliptical member slides from a central position in the direction of movement of the second latch plate of the severed shackle. Preferably the slots allow rotational motion of the elliptical member after the elliptical member has engaged with and moved the second latch plate of the unsevered member to allow clearance for re-closing of the unsevered latch member.

According to another aspect of the present invention there is provided a replaceable shackle for a padlock, the shackle comprising:

a double-ended shackle adapted to be slidably received in a lock body of the padlock so as to have a first end extending from one side of the lock body and a second end extending from the opposite side of the lock body.

Preferably said double-ended shackle is C-shaped, having a first arcuate portion at said first end and a second arcuate portion at said second end. Typically said first and second arcuate portions are substantially identical in shape and configuration. Preferably the double-ended shackle further comprises a intermediate portion joining said first and second arcuate portions in facing relation. Preferably said first and second arcuate portions and said intermediate portion all lie in a single plane.

According to a further aspect of the invention, there is provided a replaceable shackle for a padlock comprising a first end and a second end, the first end including a circular groove for receiving arms of a retaining spring in the padlock and the second end including a first notch for receiving a first latch plate in the padlock.

The first end of the shackle may include a second notch for receiving an end of the first latch plate in the closed position. Preferably the shackle is generally U-shaped.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the padlock, given by way of example only, with reference to the accompanying drawings, in which:

FIG. 1 is a perspective view of a first embodiment of a padlock according to the present invention;

FIG. 2 is an exploded view of the padlock of FIG. 1;

FIGS. 3 (a) and (b) illustrate a preferred embodiment of a double-ended shackle employed in the padlock of FIG. 1;

FIGS. 4 (a) and (b) illustrate the manner in which a lock tongue engages with the shackle employed in the padlock of FIG. 1;

FIG. 5 illustrates how the padlock of FIG. 1 can be used to lock the zipper of an item of luggage;

FIG. 6 illustrates how the shackle of the padlock of FIG. 1 can be cut by baggage inspection personnel;

FIG. 7 illustrates how the padlock of FIG. 1 can be removed from the zipper once the shackle is cut;

FIG. 8 illustrates a first step in resetting the shackle employed in the padlock of FIG. 1 by rotating the shackle 180°;

FIGS. 9 (a) and (b) illustrate what happens with the lock tongue when the shackle employed in the padlock of FIG. 1 is rotated 180°;

FIG. 10 illustrates a second step in resetting the shackle employed in the padlock of FIG. 1 by translating the shackle axially;

FIGS. 11 (a) and (b) illustrate what happens with the lock tongue in the second step of resetting the shackle as shown in FIG. 10;

FIG. 12 illustrates a third step in resetting the shackle employed in the padlock of FIG. 1 by rotating the shackle back 180°;

FIG. 13 illustrates the padlock of FIG. 1 reapplied to the zipper of an item of luggage in its reversed condition;

FIG. 14 is a perspective view of a second embodiment of a padlock in accordance with the present invention;

FIG. 15 is an exploded view of the padlock of FIG. 14;

FIG. 16 shows cross sectional views of the padlock of FIG. 14 with both shackles in the open position;

FIG. 17 shows cross sectional views of the padlock of FIG. 14 with both shackles in the closed position;

FIG. 18 shows cross sectional views of the padlock of FIG. 14 on severing the first shackle;

FIG. 19 shows cross sectional views of the padlock of FIG. 14 on ejection of the first shackle;

FIG. 20 shows cross sectional views of the padlock of FIG. 14 on initiation of release of the second shackle;

FIG. 21 shows cross sectional views of the padlock of FIG. 14 after release of the second shackle; and

FIG. 22 shows cross sectional views of the padlock of FIG. 14 after re-closing the second shackle.

### DETAILED DESCRIPTION OF PREFERRED EMBODIMENTS

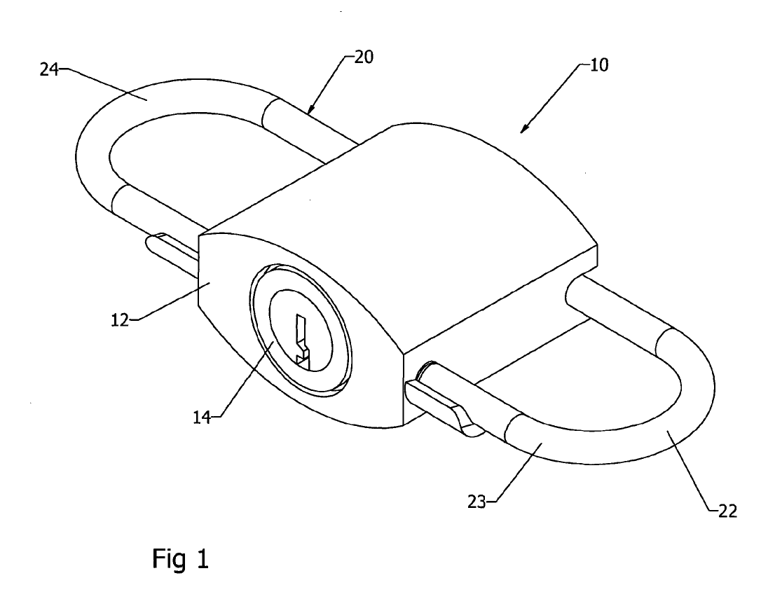

A first embodiment of a padlock 10 in accordance with the present invention is illustrated in FIGS. 1 to 13. The padlock 10 comprises a lock body 12 housing a lock mechanism 14. The lock mechanism 14 operates a plurality of shackles such that operating the lock mechanism 14 with a suitable access control means (in this case a key) is required to move a shackle from a closed position to an open position. In the embodiment shown, two shackles are provided. The two shackles are provided as an integral shackle member in the form of a double-ended shackle 20.

The double-ended shackle 20 is slidably received in the lock body 12 so as to have a first end 22, comprising the first shackle 23, extending from one side of the lock body 12 and a second end 24, comprising the second shackle 25, extending from the opposite side of the lock body 12. Each end of the shackle 20 is moveable between a closed position in which it is engaged with the lock body 12 and an open position in which it is disengaged from the lock body 12. In the embodiment shown using the double ended shackle 20, the shackle 20 is lockable in one of two conditions: a first condition, in which the first shackle 23 is in the closed position, and a second condition in which the second shackle 25 is in the closed position. The padlock 10 is arranged such that severing of the shackle in the closed position allows the shackle in the open position to be moved to the closed position. The operation will be described in more detail below.

In this embodiment the lock mechanism 14 is of conventional barrel design. However it will be understood that any other suitable lock mechanism may be employed in the padlock 10 with any suitable access control means for locking the shackle in the lock body 12, such as, for example, a combination lock or an electronic lock mechanism.

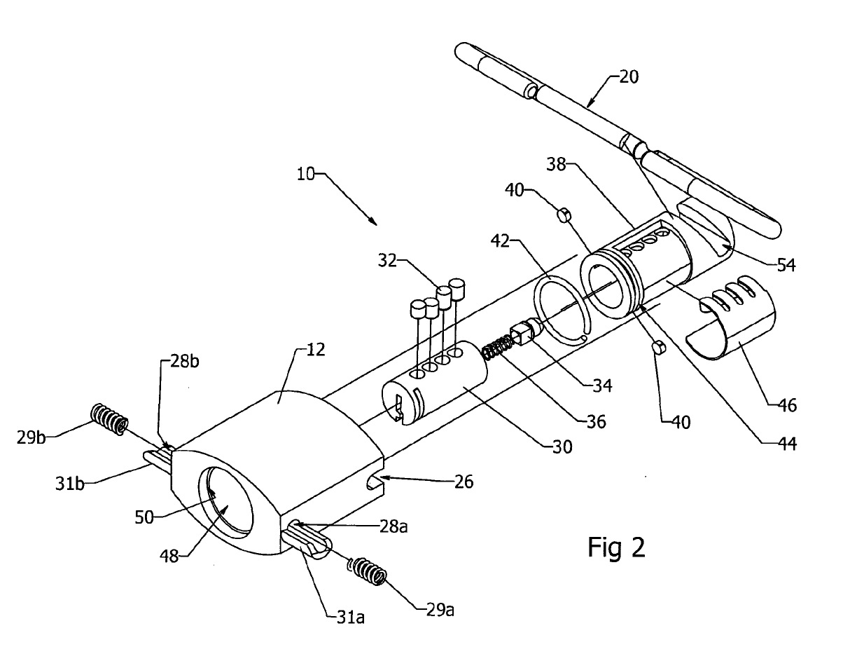

The lock mechanism 14 of this embodiment, as illustrated in FIG. 2, is in the form of a lock barrel sub-assembly comprising a key barrel 30 which comes with the required key (not shown) and is supplied to the user with the padlock 10. Four lock pins 32, a lock tongue 34, and a lock tongue spring 36 are provided in connection with the key barrel 30. The key barrel 30 is housed in an outer barrel 38, and is retained by two key barrel cam followers 40 received in respective cam grooves in the outer barrel 38, and a retaining ring 42 received in a recess 44 in the outer barrel 38. A lock pin retaining spring 46 clips over the outside of the outer barrel 38, and retains the four lock pins 32 in the key barrel 30 under a slight load. This forms the completed lock barrel sub-assembly, which is housed in a lock body cylinder 48 provided in the lock body 12. The lock barrel sub-assembly is prevented from moving rearwards by the expanded retaining ring 42 which locks over a retaining ring shoulder 50 provided within the lock body cylinder 48.

Preferably the double-ended shackle 20 is C-shaped. Typically the first and second arcuate portions 22 and 24 are substantially identical in shape and configuration. However this is by no means essential to the invention. One end of the shackle 20 could be considerably longer than the other, and/or the two ends could be of different shapes. The ends of the double-ended shackle 20 need not be arcuate but could be of any desired shape and configuration, for example of rectangular shape.

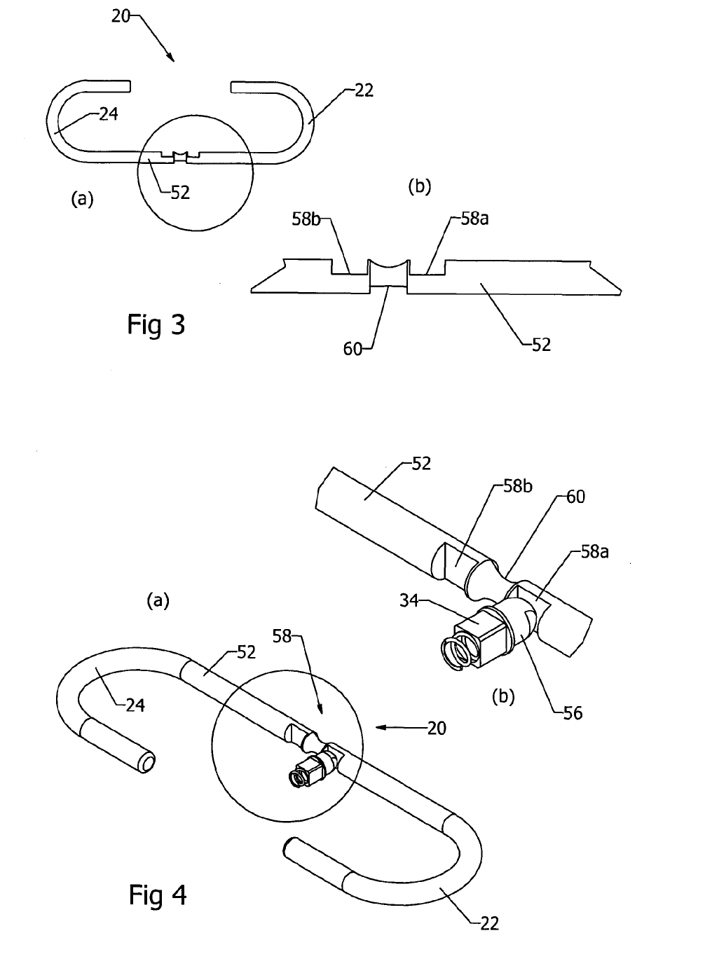

The C-shackle 20 includes an intermediate portion 52 joining the first and second ends 22 and 24, as can be seen in FIGS. 3 and 4. In this embodiment the first and second ends 22 and 24 and the intermediate portion 52 all lie in a single plane; however this also is not essential and depends on how the shackle 20 is designed to mate with the lock body 12.

The lock body 12 has a transverse groove 26 formed in the back end thereof for receiving the intermediate portion 52 of the C-shackle 20 when the lock 10 is in an assembled condition. First and second apertures 28a and 28b are provided in respective side faces of the lock body 12 for receiving the mating ends of the end portions 22 and 24 respectively of the C-shackle 20 when the lock is in either one of the first and second conditions. A respective shackle seating spring 29 is provided in each aperture 28. A half-sleeve 31 is provided adjacent each aperture 28 and is designed to support the mating ends of the C-shackle 20 when it is in its neutral position.

The intermediate portion 52 of the C-shackle 20 is received in a shackle channel 54 provided transversely in the outer barrel 38 of the lock barrel sub-assembly. The lock barrel sub-assembly is prevented from moving forwards by the C-shackle 20 as it mates with the shackle channel. The C-shackle 20 is a sacrificial shackle which can be removed from and replaced in the lock body with a replacement C-shackle, if either one of the first and second ends of the shackle 20 is damaged. Under certain conditions, the rear of the lock barrel sub-assembly can be partially exposed by ejecting it from the lock body 12 (see below). This exposes the shackle channel 54 so that a replacement C-Shackle 20 can be installed. The barrel sub-assembly can then be re-engaged with the lock body 12 to entrap the C-Shackle in the shackle channel 54 and the groove 26 of the lock body 12. Only one side of the C-Shackle is required to perform the locking function. Should one side of the C-Shackle be clipped by a Luggage Inspector for the purposes of removing the padlock 10, the opposite end of the C-shackle can be used to re-lock the device after the luggage inspection has been completed. As will be described in more detail below, no key is required to complete this process.

As can be seen most clearly in FIGS. 3 and 4, the lock tongue 34 has a rounded tip 56 with two substantially parallel, flat side faces. The intermediate portion 52 of the C-shackle 20 is provided with a portion 58 adapted to engage with the side faces of the tip 56 of lock tongue 34. The portion includes two recessed portions 58a and 58b. The first recessed portion 58a engages with the tip 56 of the lock tongue when the shackle is in the first condition, and the second recessed portion 58b engages with the tip 56 of the lock tongue when the shackle is in the second condition. FIG. 4 illustrates the tip 56 of the lock tongue engaged in the first recessed portion 58a.

Preferably the intermediate portion 52 of the C-shackle further comprises a cam portion 60 located intermediate the first and second recessed portions 58a and 58b, at a shackle mid-point. The cam portion 60 is designed to enable the lock tongue 34 to be held in a neutral position when it is disengaged from either one of the first and second recessed portions 58a and 58b. The tip 56 of the lock tongue 34 can be disengaged from either one of the first and second recessed portions 58a and 58b by rotating the C-shackle in the shackle channel 54. The amount of rotation required for disengagement will depend on the shape of the lock tongue 34 and the recessed portion 58a or 58b. In the embodiment shown, disengagement would occur on rotation by around 35 degrees. The cam portion 60 can then be engaged with the tip 56 of the lock tongue by sliding the intermediate portion 52 of the C-shackle in an axial direction in the shackle channel 54. When the C-shackle is rotated back, the tip 56 of the lock tongue acts like a cam follower and is lifted by the cam portion 60 to approximately the outer diameter of the intermediate portion 52 of the C-shackle 20. The cam portion 60 has a concave profile designed to retain the rounded tip 56 of the lock tongue 34 therein in a neutral position.

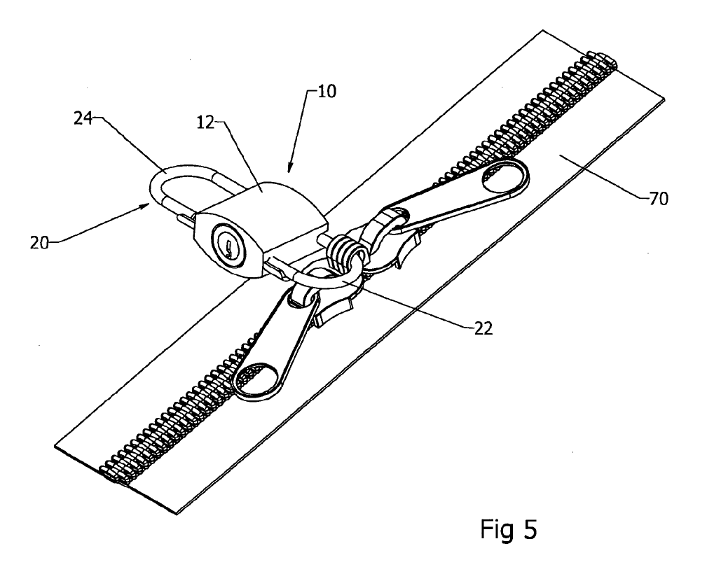

A typical procedure for using the padlock 10 for locking a zipper 70 of an item of luggage (not shown) subject to internal inspection will now be described with reference to FIGS. 5 to 13.

The padlock 10 is first presented with the C-Shackle 20 in its neutral position (i.e. neither of the two mating ends 22 and 24 are engaged in apertures 28a and 28b of the lock body 12). The lock 10 is then attached to the zipper 70 of a suitcase in a similar manner to a normal padlock, by closing one end (in the example shown, the first end 22) of the C-Shackle 20 as shown in FIG. 5. If needs be the shackle 20 can be released by the owner of the suitcase when the key is inserted into the key barrel 30 and the lock 10 is unlocked by rotating the key to its release position. This has the effect of withdrawing the tip 56 of the lock tongue 34 from the first recessed portion 58a, so that the intermediate portion 52 of the shackle 20 is free to slide in the shackle channel 54. The shackle seat spring 29 aids in this process by pushing the C-Shackle 20 to its neutral position.

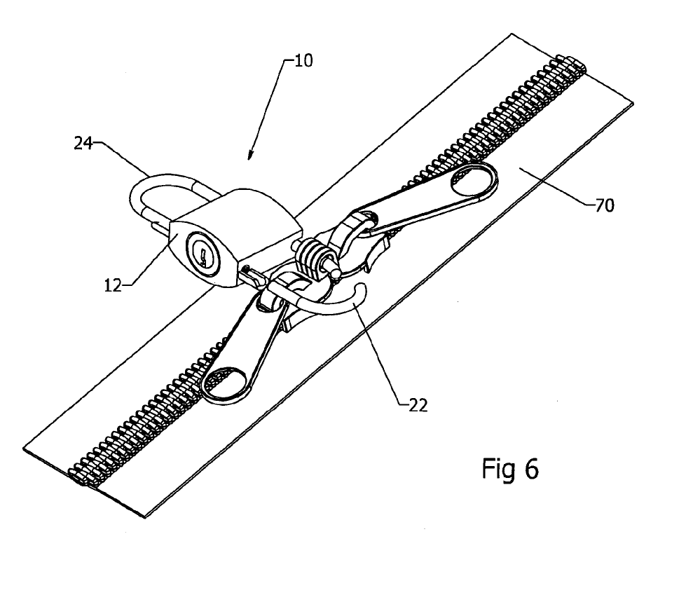

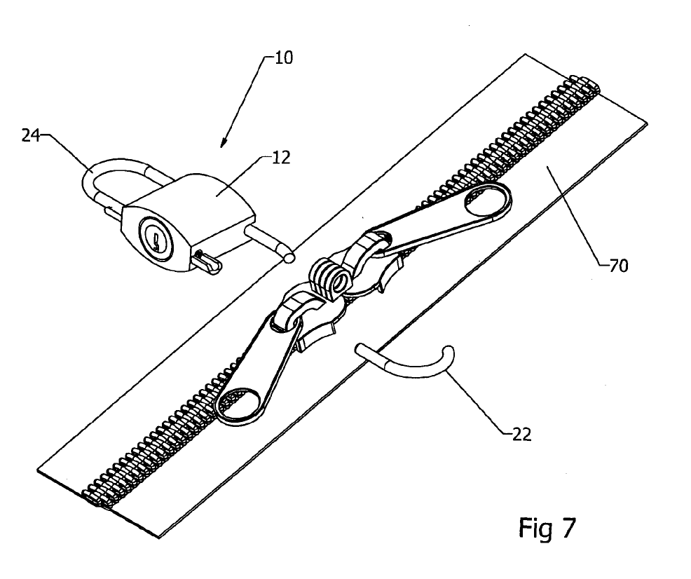

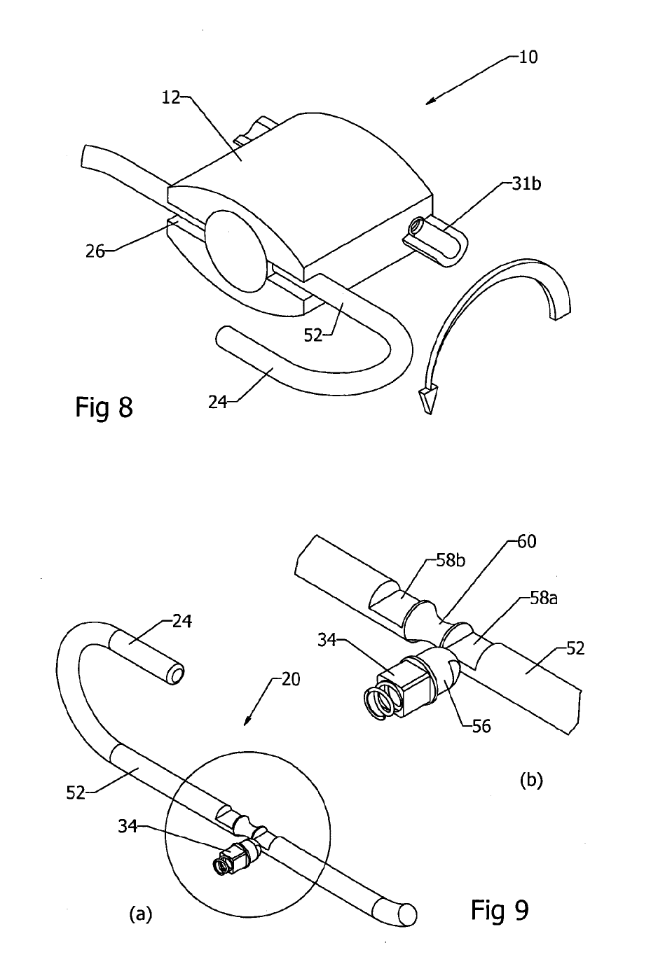

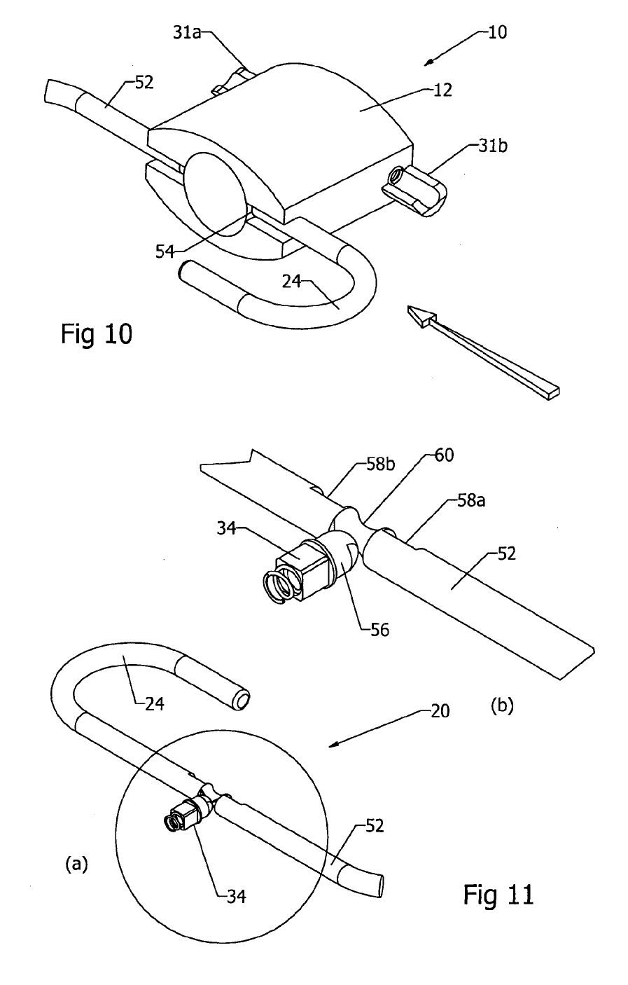

In the situation where a Luggage Inspector wishes to inspect the interior of the suitcase, he or she clips the first end 22 of the shackle 20 to remove the lock 10 as shown in FIGS. 6 and 7. The lock 10 can then be reinstated after inspection by returning the shackle 20 to its neutral position despite the absence of a key. This is accomplished by firstly rotating the C-shackle 180° as shown in FIG. 8, and then pushing the unclipped second end 24 of the C-shackle towards the lock body (one click) as shown in FIG. 10. When the C-shackle 20 is first rotated 180° the rounded tip 56 of the lock tongue 34 will slide out of the first recessed portion 58a as shown in FIG. 9. When the unclipped second end 24 of the C-shackle is pushed so as to slide the intermediate portion 52 axially in the shackle channel 54 of the lock body 12, the tip 56 of the lock tongue 34 will eventually engage in the convex surface of the cam portion 60 at the shackle mid-point, as shown in FIG. 11. The user will feel and/or hear a first “click” as the tip 56 of the lock tongue 34 seats in the cam portion 60. The C-shackle 20 is now in its neutral position.

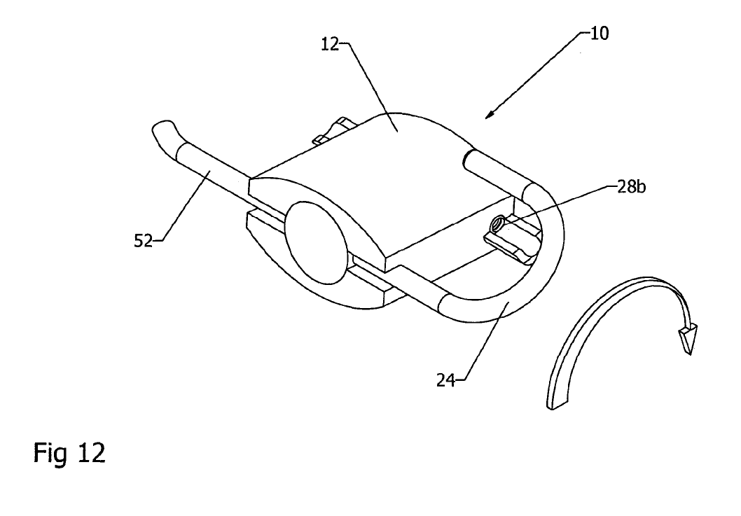

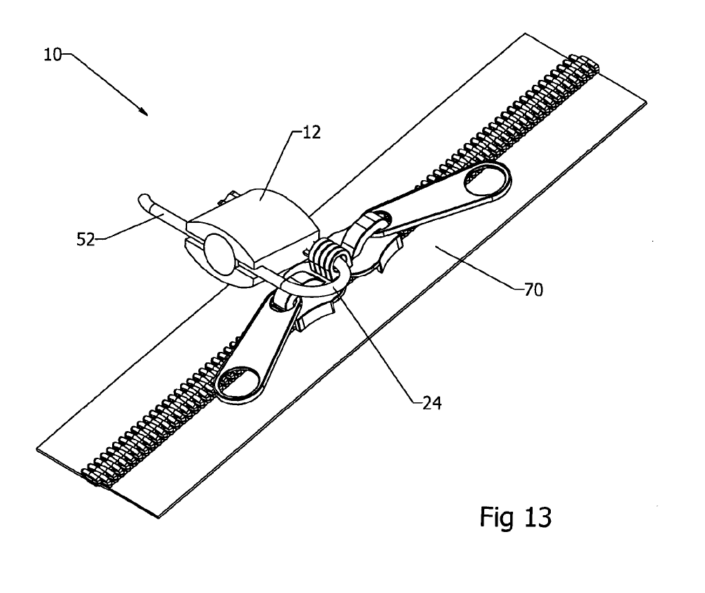

The C-Shackle 20 is then rotated 1800 back to its operating position, as shown in FIG. 12, and the lock 10 can then be used once more, albeit by utilising the opposite end 24 of the shackle. The second end 24 of the shackle 20 can be applied to the zipper 70 as shown in FIG. 13. The lock 10 is relocked by pushing the mating end of the shackle into the second aperture 28b. This will have the effect of forcing the second recessed portion 58b, on the intermediate portion 52 of the shackle, to engage the tip 56 of the lock tongue 34. The user will feel and/or hear a second “click” as the tip 56 seats in the second recessed portion 58b.

A used (clipped) C-shackle 20 can be replaced with a new (spare) C-shackle. This is done by inserting the key into the front face of the barrel sub-assembly and rotating it 90° in a clockwise direction. This rotates the key barrel 30 in relation to the outer barrel 38, and aligns the deeper ends of the two cam grooves of the key barrel with the two key barrel cam followers 40. This gives the key barrel cam followers 40 the required space to be displaced radially inwards when the retaining ring 42 is compressed. The retaining ring 42 is compressed by the retaining ring shoulder 50 when the front face of the barrel sub-assembly is pushed inwards (rearwards) relative to the lock body 12. This allows the barrel sub-assembly to slide along the lock body cylinder 48 rearwards, and causes the opposite end of the barrel sub-assembly to emerge from the lock body 12. The shackle channel 54 will thus be exposed allowing the damaged C-shackle to be replaced. The movement of the barrel sub-assembly in relation to the lock body 12 is restricted by the boss of the lock key (not shown), which is wider than the diameter of the lock body cylinder 48. The installation of the new C-shackle 20 is completed when the shackle has been aligned with the transverse groove 26 in the lock body 12, and when the barrel sub-assembly has been pushed back into the lock body 12. The retaining ring 42 once again expands to the locked position as it passes the retaining ring shoulder 50 in the lock body cylinder 48. At this stage, the key can be removed.

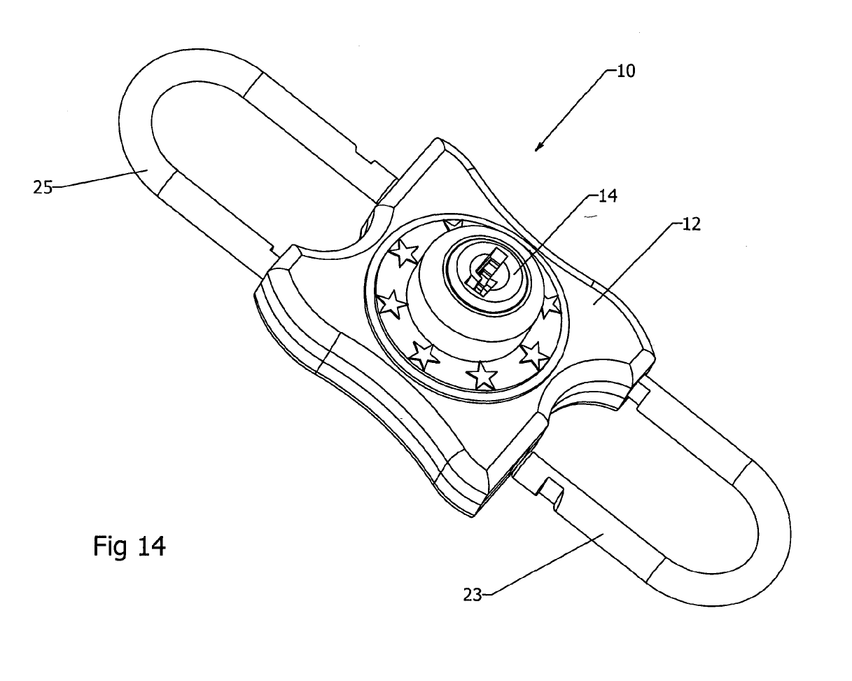

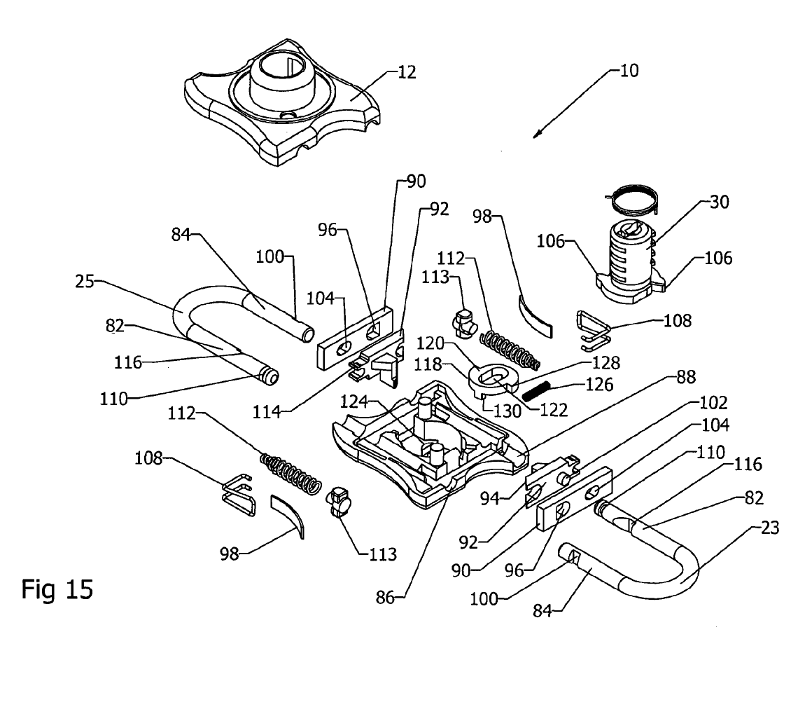

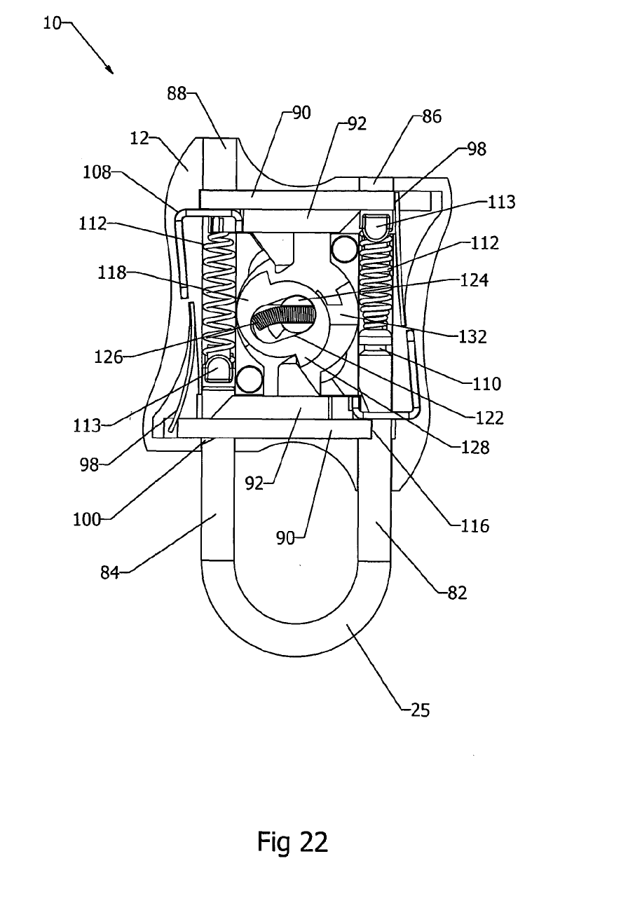

FIGS. 14 to 22 show a second embodiment of a padlock 10 in accordance with the present invention. Again in this embodiment, the padlock comprises a lock body 12 housing a locking mechanism 14. Also, two shackles are provided. In this example however, the first and second shackles 23 and 25 are provided as separate elements. Further, the first and second shackles may both independently be in either a closed or open position. In the embodiment shown in FIGS. 1 to 13, one of the shackles remained in the open position and severing of the other shackle allowed the open shackle to be moved to the closed position. In the embodiment of FIGS. 14 to 22, both of the first and second shackles 23 and 25 may simultaneously be in the closed position. In this state, severing one of the shackles results in the other shackle moving to the open position, from which it is free to move back to the closed position. The operation will be described in more detail below.

The first and second shackles 23 and 25 each comprise a generally U-shaped member having a first end 82 and a second end 84. The lock body 12 is provided with first and second longitudinal openings 86 and 88 such that the ends of the first shackle 23 are received in the longitudinal openings 86 and 88 on a first side of the body 12 and the ends of the second shackle 25 are received in the first and second longitudinal openings 86 and 88 on a second side of the lock body 12. The first end 82 of the first shackle 23 is therefore co-linear with the second end 84 of the second shackle 25 and the second end 84 of the first shackle 23 is co-linear with the first end 82 of the second shackle 25.

The locking mechanism 14 comprises a key barrel 30 mounted in the lock body 12. The key barrel 30 can be rotated by a corresponding key (not shown) such that rotation of the key releases the second ends 84 of the first and second shackles 23 and 25 from the lock body 12.

Each shackle 23 and 25 is provided with a first latch plate 90, a second latch plate 92 and a latch spring 98. Each of the latch plates 90 and 92 are mounted generally transverse to ends of the corresponding shackle 23 and 25. The first latch plate 90 includes a first hole 96 that receives the second end 84 of the corresponding shackle 23 or 25. The first latch plate 90 is spring biased by a latch spring 98 to move towards the first end 82 of the shackle. The second end 84 of the shackle includes a first notch 100 such that the first notch 100 engages with the first hole 96 to retain the second end 84 of the shackle.

The second latch plate 92 includes a lug 102 that is received in a second hole 104 in the first latch plate 90 such that movement of the second latch plate 92 causes movement of the first latch plate 90. The second latch plate 92 is engaged by protrusions 106 on the key barrel 30 such that rotation of the key barrel 30 causes sliding motion of the second latch plate 92 towards the second end 84 of the shackle 23 or 25.

The first ends 82 of the shackles 23 and 25 are each retained in the lock body 12 by a corresponding retaining spring 108. The retaining spring 108 includes a pair of spring biased arms which engage with a circular groove 110 adjacent the first end 82 to prevent the first end 82 being removed from the lock body 12. Further, the longitudinal openings 86 and 88 are provided with ejector springs 112 extending between ends of the shackles 23 and 25 to bias the shackles 23 and 25 to move outwardly relative to the lock body 12. The ejector springs 112 are provided with latch cam members 113 received in the ends of the ejector springs adjacent the second ends of the shackles 23 and 25. The latch cam members 113 slide in channels provided in the longitudinal openings 86 and 88.

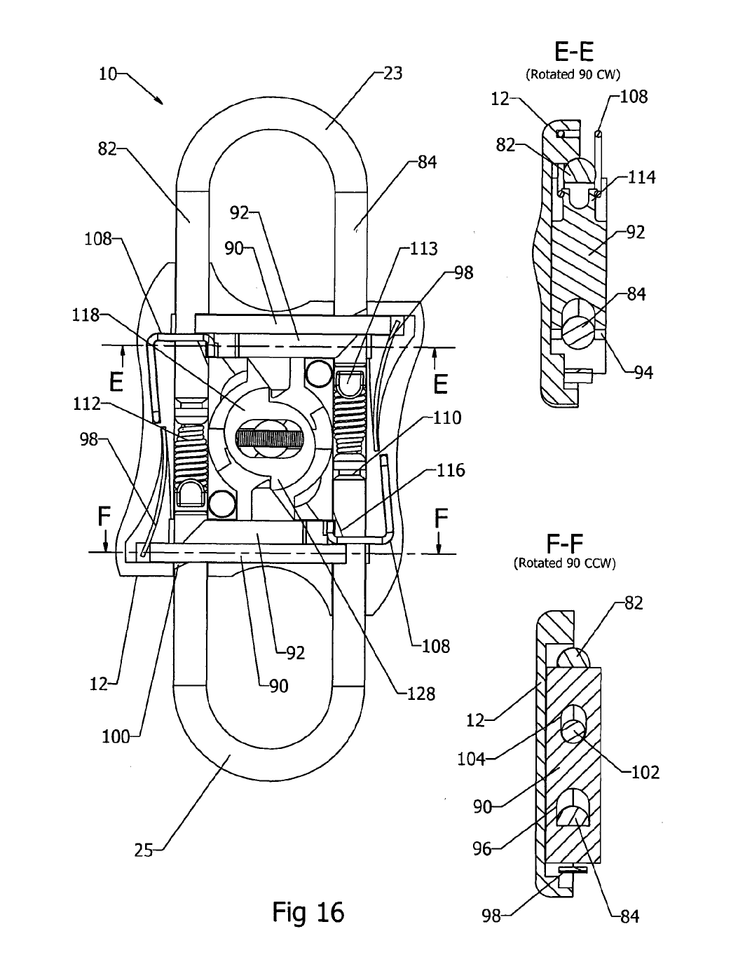

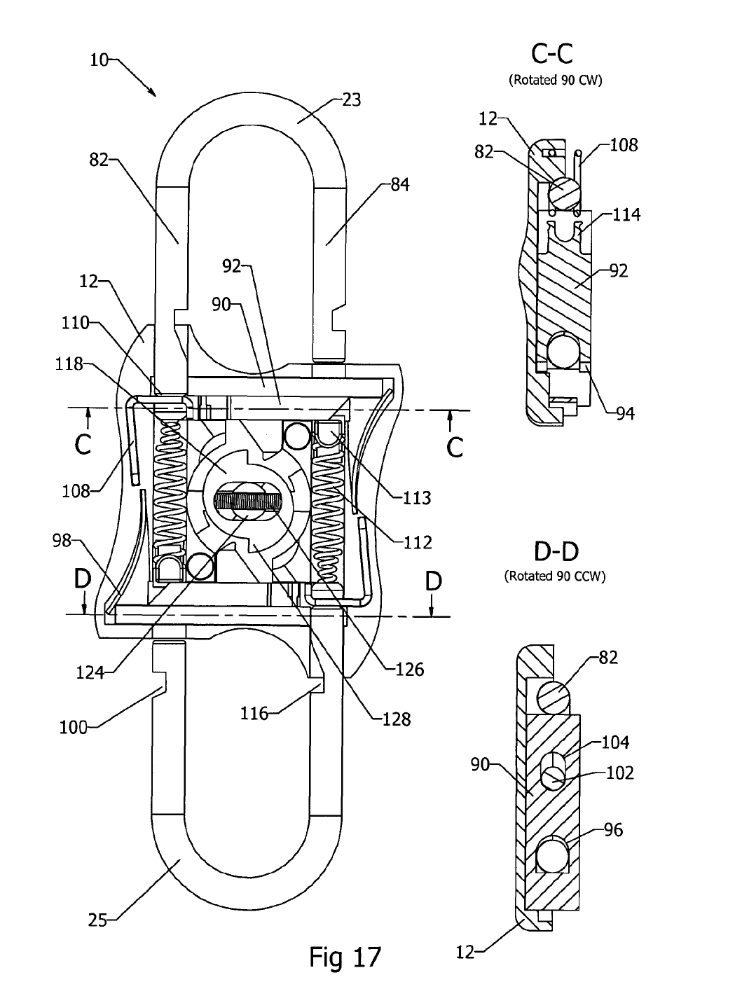

The normal, key operated opening and closing of the shackles 23 and 25 can be seen with reference to FIGS. 16 and 17. Rotation of the key barrel 30 causes movement of the second latch plates 92 towards the second ends 84 of the shackles 23 and 25 by engagement with the protrusions 106. The second latch plate 92 moves the first latch plate 90 such that the edge of the first hole 96 disengages from the first notch 100. The ejector springs 112 push the shackles 23 and 25 away from the lock body 12 until the retaining springs 108 engages with the circular grooves 110. Both shackles 23 and 25 are then in the open position and can be closed by the reverse action.

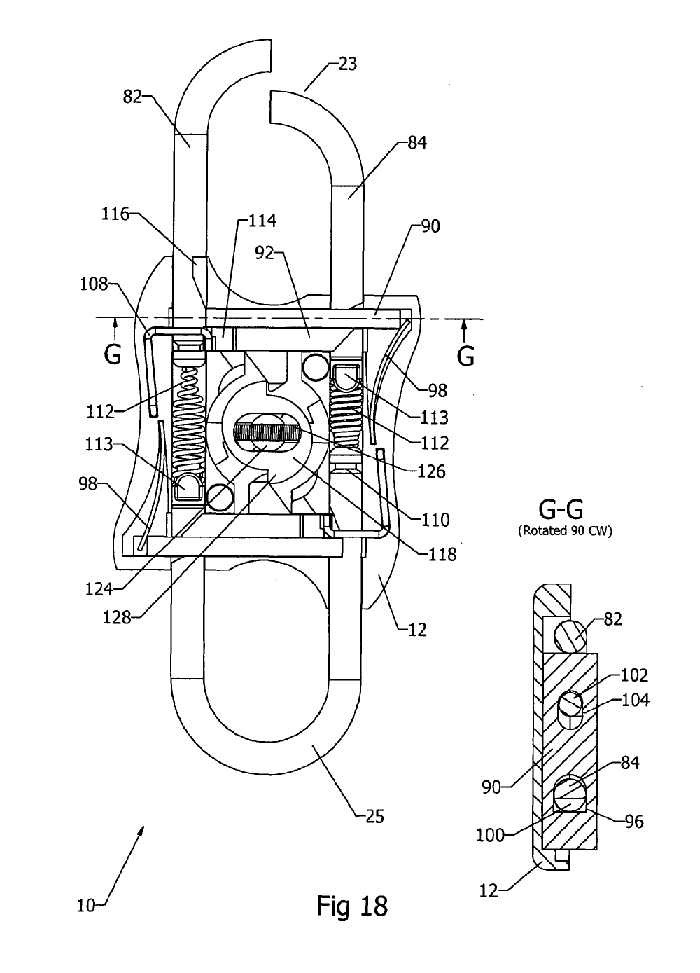

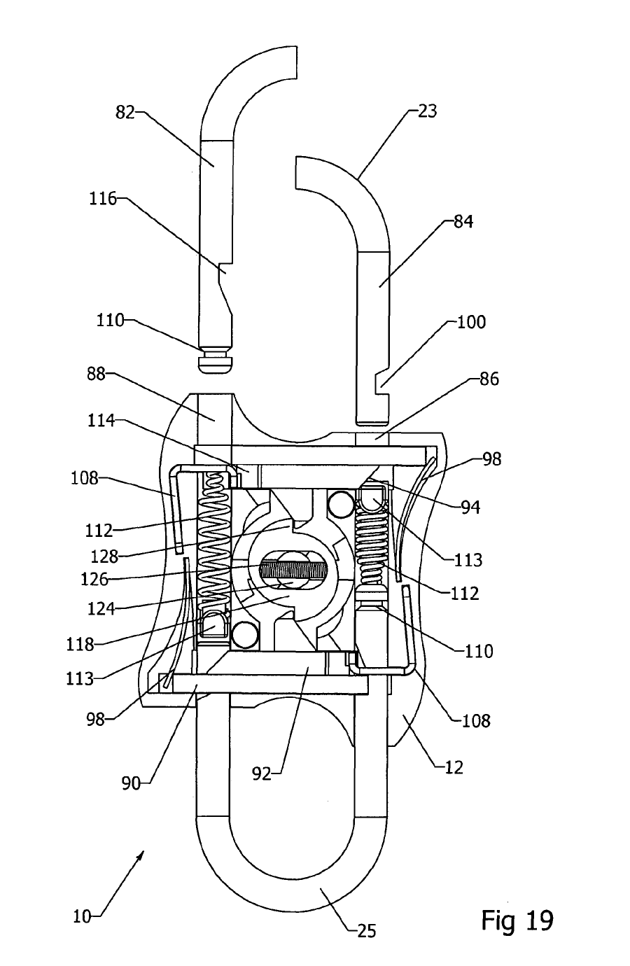

When it is required for a closed shackle 23 or 25 to be opened via severing the shackle, the operation is as shown in FIGS. 18 and 19. The second latch plate 92 includes an end 114 adjacent the first end 82 of the shackle 23 or 25 that engages with the retaining spring 108 when the shackle 23 or 25 is in the closed position. The end 114 of the second latch plate 92 spreads the arms of the retaining spring 108 in the closed position. As can be seen in FIGS. 18 and 19, if the first shackle 23 is severed, the first end 82 is therefore free to be ejected from the lock body 12 by the ejector spring 112.

The first end 82 of the shackle 23 also includes a second notch 116 in which the adjacent end of the first latch plate 90 rests in the closed position. The second notch 116 is tapered such that as the first end 82 is being ejected, the first latch plate 90 rides up and out of the second notch 116. This action moves the first latch plate 90 towards the second end 84 of the shackle 23 thereby disengaging the first hole 96 from the first notch 100 and allowing the second end 84 of the shackle to also be ejected from the lock body 12 (as shown in FIG. 19).

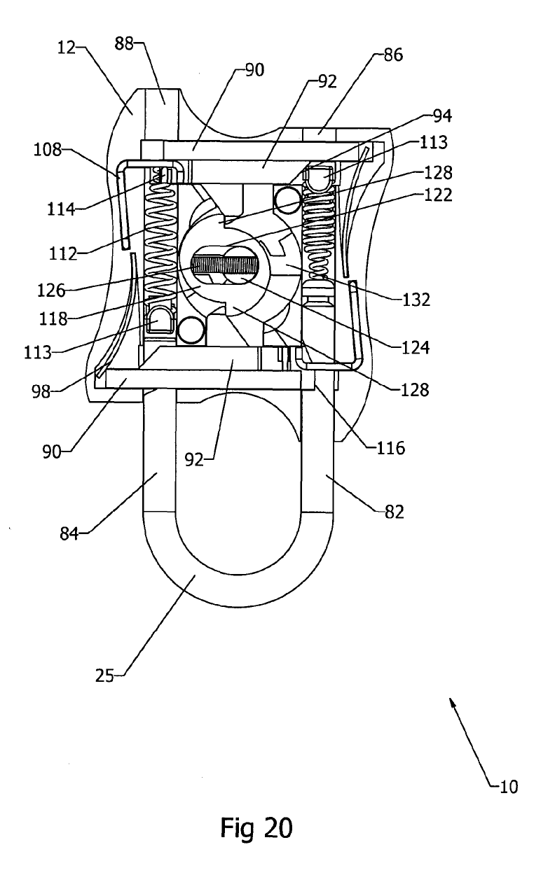

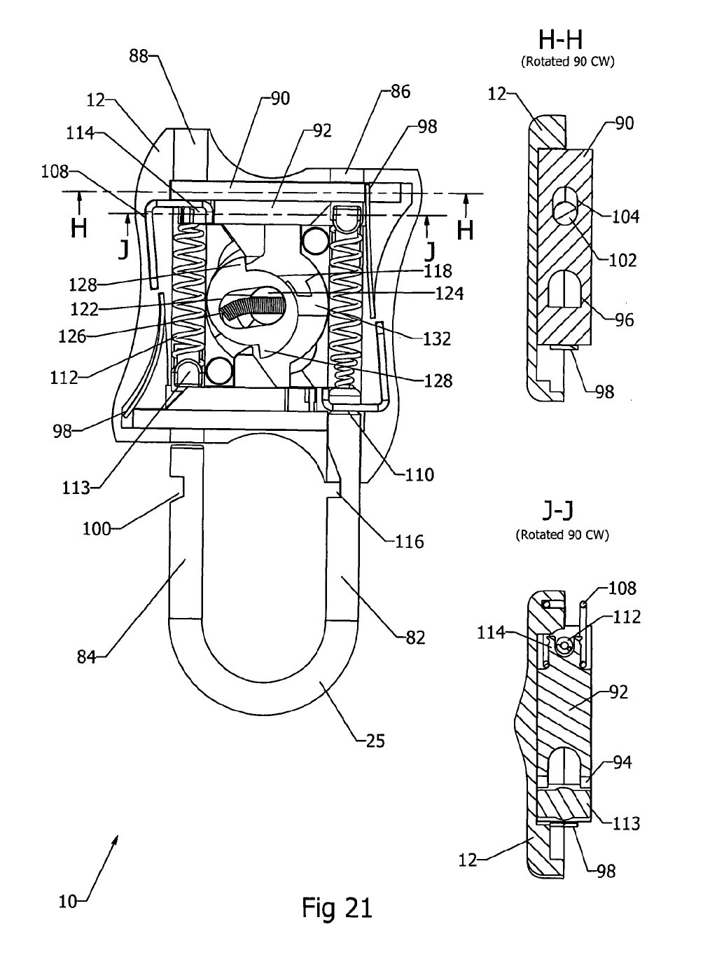

On ejection of the first end 82 and the second end 84 of the shackle 23, the second latch plate 92 move further towards the first longitudinal opening 86 under the action of the latch spring 98. The padlock 10 is also provided with a latch interconnect member 118 such that this movement of the second latch plate 92 causes movement of the second latch plate 92 of the second shackle 25 (as seen in FIG. 20). The movement of the second latch plate 92 of the first shackle 23 caused by the latch spring 98 is limited by the balancing action of the latch spring 98 of the second shackle 25 (through the latch interconnect member 118). However, on ejection of the second end 84 of the first shackle 23, the latch cam member 113 acts against an angled end surface 94 of the second latch plate 92 (as can be seen in FIG. 19) to move the second latch plate 92 and thereby the first latch plate 90 towards the first longitudinal opening 86. The first latch plate 90 therefore moves across to seal the longitudinal openings 86 and 88 as can be seen in FIG. 21.

The arrangement of the first and second notches 100 and 116 in the shackle 23 is also such that rotation of either end 82 or 84 of the severed shackle will result in ejection of both the first and second ends 82 and 84 of the severed shackle 23. As each of the first and second notches 100 and 116 are provided in one side only of the end 82 and 84, rotation of either end 82 and 84 disengages that notch from the first latch plate 90 and causes movement of the first latch plate 90 such that the other notch is also disengaged. Therefore, in the event that the ends 82 and 84 of the shackle 23 are not ejected as described previously, rotation of either end 82 and 84 will cause this to happen. As it is expected that someone severing the shackle 23 will need to cause such rotation to remove the padlock 10, this ensure that the device operates correctly in unforseen circumstances.

The latch interconnect member 118 comprises an elliptical member 120 having an elliptical central opening 122. A post member 124 is provided on the inside of the lock body 12. The post member 124 is received in the elliptical opening 122. Also provided is an interconnect spring 126 extending across the elliptical opening 122 and through a slot in the post member 124. The elliptical member 120 includes opposed arms 128 engaged by the second latch plates 92 such that motion of the second latch plate 92 of the first shackle 23 when cut causes motion of the second latch plate 92 of the second shackle 25.

The lower surface of the elliptical member 120 also includes lugs 130 which slide inside slots 132 in the inner surface of the lock body 12. The slots 132 allow the elliptical member 120 to slide initially parallel to the motion of the second latch plates 92. As shown in FIG. 21, the elliptical member 120 having moved to engage and move the second latch plate 92 of the second shackle 25 then partially rotates by movement of the lugs 130 in the slots 132 deforming the interconnect spring 126. This rotational motion allows clearance for the first latch plate 90 of the second shackle 25 to re-engage with the second shackle 25 to allow the second shackle to be closed (as shown in FIG. 21) without the first shackle 23.

As in the first described embodiment, the severed shackle 23 can be later replaced, restoring the padlock 10 to its original condition for re-use.

Now that preferred embodiments of the padlock have been described in detail, it will be apparent that it provides a number of advantages over the prior art, including the following:
(i) Once clipped by a Luggage Inspector of the TSA or other luggage screening authority, the lock can be easily refitted post-inspection without the need for a pass-key.
(ii) Unauthorised access post inspection can only be achieved by cutting the second lock portion.
(iii) A self-evident indication of the inspection and/or the interference is thus automatically provided to the owner.
(iv) Spare shackles can be marketed as a consumable component.
(v) The lock has been designed to work in conjunction with a zip immobilisation system.

It will be readily apparent to persons skilled in the relevant arts that various modifications and improvements may be made to the foregoing embodiments, in addition to those already described, without departing from the basic inventive concepts of the present invention. For example, it is not essential that the shackle be replaceable; the lock could be designed as a single use item so that once it has been clipped by a Luggage Inspector a new lock would need to be purchased. Therefore, it will be appreciated that the scope of the invention is not limited to the specific embodiments described.

1. A padlock comprising:
a lock body;
a plurality of shackles extending from the lock body, each shackle being moveable between a closed position and an open position; and
a locking mechanism engageable with each of the shackles such that operation of the locking mechanism with an access control means is required to move any shackle in the closed position to the open position;
wherein severing one of the shackles in the closed position results in one of the other shackles being in the open position and free to move to the closed position.

2. A padlock in accordance with claim 1, wherein when one of the shackles is in the closed position, the other shackles are prevented from being in the closed position and severing the closed shackle allows closing of one of the open shackles.

3. A padlock in accordance with claim 2, wherein each of the shackles further comprise part of an integral shackle member.

4. A padlock in accordance with claim 3, wherein the integral shackle member comprises a double sided shackle, the first end of the double sided shackle further comprising a first shackle and the second end of the double sided shackle comprising a second shackle such that moving the first shackle to the closed position results in the second shackle being moved to the open position and moving the first shackle to the open position results in the second shackle being moved to the closed position.

5. A padlock in accordance with claim 4, wherein each of the shackles move slidably between the closed and open positions and each of the shackles interengage such that rotation of a portion of the severed shackle causes the other shackle to move to the open position by said interengagement.

6. A padlock in accordance with claim 5, wherein the double sided shackle comprises an intermediate portion between the first and second ends and the locking mechanism includes a tongue member that engages with a first recessed portion in the intermediate portion when the first shackle is in the closed position and with a second recessed portion in the intermediate portion when the second shackle is in the closed position such that engagement of the tongue member with either the first or second recessed portions prevents sliding movement of the double sided shackle and wherein rotational motion of the double sided shackle is prevented by one of the shackles being in the closed position.

7. A padlock in accordance with claim 6, wherein the intermediate portion comprises a cam portion between the first and second recessed portions and wherein the first and second recessed portions are arranged such that rotational motion of the double sided shackle after severing the closed shackle moves the tongue member out of the recessed portion and allows the double sided shackle to slide to a position in which the tongue member is in the cam portion, the double sided shackle then being in a neutral position with neither the first or second shackles being closed.

8. A padlock in accordance with claim 1, wherein the severed shackle is removable from the lock body for replacement.

9. A padlock in accordance with claim 6, wherein the intermediate portion is received in a transverse groove in the lock body and wherein the double sided shackle can be removed from the transverse groove to allow replacement of the double sided shackle.

10. A padlock in accordance with claim 1, wherein the locking mechanism comprises a lock barrel and the access control means comprises a key.

11. A padlock in accordance with claim 1, wherein the locking mechanism comprises a combination type lock.

12. A padlock in accordance with claim 1, wherein each of the shackles can simultaneously be in the closed position and severing of any shackle in the closed position causes other shackles in the closed position to move to the open position.

13. A padlock in accordance with claim 12, wherein the padlock further comprises a first shackle and a second shackle extending from opposed sides of the lock body.

14. A padlock in accordance with claim 13, wherein the locking mechanism further comprises a key barrel arranged in the lock body such that rotation of the key barrel with a key causes the first and second shackles to move to the open position.

15. A padlock in accordance with claim 12, wherein the locking mechanism further comprises a combination type lock and operation of the combination type lock causes the first and second shackles to move to the open position.

16. A padlock in accordance with claim 14, wherein each of the first and second shackles comprises a first end and a second end, the first end being retained in the lock body by a retaining spring in the open position and the second end being engaged by a first latch plate in the closed position to hold the second end in the lock body in the closed position.

17. A padlock in accordance with claim 16, wherein a second latch plate is provided in engagement with the first latch plate and the key barrel such that rotation of the key barrel causes translation of the second latch plate and thereby of the first latch plate.

18. A padlock in accordance with claim 17, wherein the first latch plate comprises a first hole into which is received the second end of the shackle, the second end having a first notch engaged by the edge of the hole to retain the second end of the shackle in the closed position.

19. A padlock in accordance with claim 18, wherein the retaining spring comprises a pair of arms that engage with a circular groove in the first end of the shackle to retain the shackle and the second latch plate engages with the arms of the retaining spring in the closed position such that severing the shackle in the closed position allows release of the first end of the shackle from the lock body.

20. A padlock in accordance with claim 19, wherein ejector springs are provided between the first end of the first shackle and the second end of the second shackle and between the second end of the first shackle and the first end of the second shackle such that the ejector springs eject the first end of the severed shackle from the lock body.

21. A padlock in accordance with claim 20, wherein the first ends of the first and second shackles comprise a second notch which receives an end of the corresponding first latch plate and wherein during the ejection of the first end of the shackle, the first latch plate rides out of the second notch disengaging the first latch plate from the second end of the severed shackle, thereby allowing ejection of the second end of the severed shackle by the ejector spring.

22. A padlock in accordance with claim 21, wherein the first and second notches are shaped such that rotation of either the first end or the second end of the severed shackle causes movement of the first latch plate to disengage the first latch plate from both the first and second notches, thereby allowing ejection of the first and second ends of the severed shackle.

23. A padlock in accordance with claim 18, wherein a latch interconnect member is provided, the latch interconnect member being engaged by the second latch plate of the severed shackle such that the latch interconnect causes movement of the second latch plate and the first latch plate of the unsevered shackle to allow the unsevered shackle to move to the open position.

24. A padlock in accordance with claim 23, wherein the latch interconnect comprises an elliptical member having opposed arms that engage with the second latch plates of the first and second shackles, the elliptical member having an elliptical opening receiving a post member provided on the inside of the lock body.

25. A padlock in accordance with claim 24, wherein the lower surface of the elliptical member comprises lugs which slide in slots provided in the inner surface of the lock body such that the elliptical member slides from a central position in the direction of movement of the second latch plate of the severed shackle.

25. A padlock in accordance with claim 24, wherein the slots allow rotational motion of the elliptical member after the elliptical member has engaged with and moved the second latch plate of the unsevered member to allow clearance for re-closing of the unsevered latch member.

27. A replaceable shackle for a padlock comprising a double-ended shackle adapted to be slidably received in a lock body of the padlock so as to have a first end extending from one side of the lock body and a second end extending from the opposite side of the lock body.

28. A replaceable shackle for a padlock in accordance with claim 27, wherein the shackle is C-shaped, having a first arcuate portion at said first end and a second arcuate portion at said second end.

29. A replaceable shackle for a padlock in accordance with claim 28, wherein said first and second arcuate portions are substantially identical in shape and configuration.

30. A replaceable shackle for a padlock in accordance with claim 28, wherein the double-ended shackle further comprises a intermediate portion joining said first and second arcuate portions, the first and second arcuate portions and the intermediate portion all lying in a single plane.

31. A replaceable shackle for a padlock comprising a first end and a second end, the first end comprising a circular groove for receiving arms of a retaining spring in the padlock and the second end including a first notch for receiving a first latch plate in the padlock.

32. A replaceable shackle in accordance with claim 31, wherein the first end of the shackle comprises s a second notch for receiving an end of the first latch plate in the closed position.

33. A replaceable shackle for a padlock in accordance with claim 31, wherein the shackle is generally U-shaped.
